(19) United States
(12) Patent Application Publication
(10) Pub. No.: US 2014/0374331 A1
(43) Pub. Date: Dec. 25, 2014

(54) FILTER SYSTEM

(71) Applicant: Robert A. ANDERSON, Ashby, MN (US)

(72) Inventor: Robert A. ANDERSON, Ashby, MN (US)

(21) Appl. No.: 14/484,101

(22) Filed: Sep. 11, 2014

Related U.S. Application Data
(63) Continuation-in-part of application No. PCT/US2013/030523, filed on Mar. 13, 2013.

(51) Int. Cl. B01D 29/13; B01D 29/60; B01D 29/58

(52) U.S. Cl. CPC B01D 29/13; B01D 29/58; B01D 29/605
USPC 210/137; 210/416.1; 210/335; 210/289; 210/416.5

(57) ABSTRACT

A filter system including a vacuum source for generating a vacuum flow and a container. The container includes an inflow port for receiving contaminated liquids and solids, a filter assembly for filtering contaminated solids from the contaminated liquids and an outflow port for delivering filtered liquids from the container. The vacuum flow proceeds through the container so that the filtered liquids are drawn through the filter assembly towards the outflow port. The contaminated solids receive vacuum pressure continuously to complete the filter process above the top filter.

### RELATED APPLICATION

This application is a continuation-in-part of PCT International Patent Application PCT/US13/30523, filed Mar. 12, 2013, entitled Suspended Solids Filter System, the contents of which are incorporated herein by reference in their entirety.

### TECHNICAL FIELD

The present invention is directed to the filtering of contaminated liquid generated during industrial processes such as oil drilling.

### BACKGROUND

During various industrial and commercial processes, solids and liquids are combined that benefit from being separated as close to the source and point of generation as possible. For example, during an oil drilling process, debris (comprised of water, oil, stone, soil, metal fragments, mud and other components) is generated and stored in an approved holding tank or pond adjacent to the drilling rig as waste material or sludge. This mixture of solids and liquids must be treated according to industry standards based on contaminant levels, disposal, recycling or beneficial reuse of the various components of solids and liquids. These concerns stem both from the potential adverse health effects of the contaminated water reentering the aquifer, or environmental concerns and the impact on the generators Operating Expenses to manage the same. The contaminated liquid, which is removed, must be trucked to disposal areas and pumped below the aquifer into detention areas which are then sealed, or receive further treatment for beneficial reuse or other purposes. Contaminated liquid filtration has conventionally been a slow process given limited advancements in filtration technology and the added challenges of the often proprietary and complex chemical makeup or profile of the liquids, as the contaminants must be removed before transport. The most common method currently available for separating the solids from liquids involves the use of a sock type filter. This method is slow and cumbersome and requires many changes of the filter, causing serious time delays when filling the transport trucks.

While other types of liquid filters designed to separate solids are available in different industries, such as filter belt press, dissolved air flotation, plate and frame press, centrifuge, cyclone, shaker filters and settling lagoons, the sock method is the most cost effective technique which has been acceptable to date for the filtering of contaminants from liquid at drilling sites, such as Flowback Water, Processed Water and Tank Cleaning wastewater. However, as mentioned previously, frequent filter changes are required, substantially slowing the transport process. Further, following scheduled filter replacements is crucial to eliminate the possibility of contamination blinding the wastewater well pumps, but the fact that each load's solids content varies and is not specifically known does not allow for predictable and regular filter replacements. Thus, the operator must wait until the filter clogs, before replacing the filter. This slows the filtering process, substantially increasing the waiting time and operating costs for all involved, including the trucking company, disposal site and disposal customer.

One of the key difficulties faced in using the filter sock method is the complexity of the contaminated liquids. The liquid may contain particles of varying sizes, oil and tar. Filter life is dependent on how much of these components are present in the contaminated liquid and there is no easy way to segregate out the most damaging components to improve filter life.

### SUMMARY OF THE INVENTION

An object of the present invention is to provide an improved liquid filter that operates continuously with minimal energy requirements and is more effective in volume and gallon per minute process speed in separating and drying solids contained within the combined liquids and solids, along with other pollutants, from liquids at contaminated combined solids and liquid sources.

A filter system according to an exemplary embodiment of the present invention comprises: a vacuum source for generating a vacuum flow; and a container comprising: an inflow port for receiving contaminated liquid; a filter assembly for filtering solid contaminants from the contaminated liquid; and an outflow port for delivering filtered liquid from the container, the vacuum flow proceeding through the container so that the filtered liquid is drawn through the filter assembly towards the outflow port.

In at least one exemplary embodiment, the container is made of steel.

In at least one exemplary embodiment, the suspended solids filter system further comprises an internal inflow pipe in communication with the inflow port, the internal inflow pipe comprising one or more nozzles for delivery of the contaminated liquid to the filter assembly.

In at least one exemplary embodiment, the suspended solids filter system comprises shield elements that protect the container from contact with the contaminated liquid delivered from the nozzles.

In at least one exemplary embodiment, the filter assembly comprises at least one perforated plate and at least one woven screen.

In at least one exemplary embodiment, the filter assembly further comprises at least one layer of aggregate.

In at least one exemplary embodiment, the aggregate is made up of at least one of coal slag, iron ore slag, crushed granite or coarse sand.

In at least one exemplary embodiment, the filter assembly comprises an upper filter assembly and a lower filter assembly.

In at least one exemplary embodiment, the suspended solids filter system further comprises an outflow pipe through which filtered liquid is drawn out of the container.

In at least one exemplary embodiment, the contaminated liquid comprises at least one of water, sewage, diesel fuel, crude oil, saltwater, invert drilling fluid, dredge material, mining pond water, concrete washout material, paper manufacturing waste water, recycled motor oil and aggregate and sand washing material.

In at least one exemplary embodiment, the container has a capacity within the range of 0.1 cubic yards to 200 cubic yards.

In at least one exemplary embodiment, the container comprises walls, interior surfaces of the walls being coated with a protective coating.

In at least one exemplary embodiment, the protective coating comprises a material selected from a list of materials consisting of: epoxy resin, conductive polymer nanodispersions and bioplastics.

In at least one exemplary embodiment, the container further comprises a manway that allows access to the contaminated liquid within the container so that contaminants may be removed from the top surface of the contaminated liquid.

In at least one exemplary embodiment, the suspended solids filter system further comprises a pump that removes the filtered liquid from the container.

In at least one exemplary embodiment, the suspended solids filter system further comprises a transfer tank that receives the filtered liquid from the container.

In at least one exemplary embodiment, the transfer tank comprises a sensor that determines a level of the filtered liquid in the transfer tank so that upon a condition that the level of the filtered liquid reaches a predetermine level, the pump is activated to maintain operation of the filter system under vacuum pressure.

In at least one exemplary embodiment, the container comprises an opening and a door that is moveable between a closed position in which the door covers the opening and an open position in which the door allows contaminants to be removed from the container through the opening.

In at least one exemplary embodiment, the suspended solids filter system further comprises a lift that moves the container to a dumping configuration.

In at least one exemplary embodiment, the suspended solids filter system further comprises a hydraulic system that operates the door and the lift.

In at least one exemplary embodiment, the outflow port is disposed below the filter assembly.

Other features and advantages of embodiments of the invention will become readily apparent from the following detailed description, the accompanying drawings and the appended claims.

### BRIEF DESCRIPTION OF THE DRAWINGS

Various exemplary embodiments of this invention will be described in detail, with reference to the following figures, wherein:

FIG. 1 is a perspective view of a filter according to an exemplary embodiment of the present invention;

FIG. 2 is an exploded perspective view of the filter of FIG. 1;

FIG. 3 is a perspective view of an inflow pipe useable with the filter of FIG. 1 according to an exemplary embodiment of the present invention; and

FIG. 4 is a diagram illustrating a process by which sludge is removed from a body of water according to an exemplary embodiment of the present invention.

FIG. 5 is a perspective view of a filter system according to an exemplary embodiment of the present invention;

FIG. 6 is a cross-sectional view of the filter system of FIG. 5;

FIG. 7 is a cross-sectional view of a filter assembly according to an exemplary embodiment of the present invention;

FIG. 8 is a profile view of a filter system according to an exemplary embodiment of the present invention;

FIG. 9 is a top plan view of the filter system of FIG. 8;

FIG. 10 is a bottom plan view of the filter system of FIG. 8;

FIG. 11 is a perspective view of the interior of the container of the filter system of FIG. 8;

FIG. 12 is a profile view of the filter system of FIG. 8 shown in the dumping configuration;

FIG. 13 is a perspective view of the door of the filter system of FIG. 8 in the open configuration;

FIG. 14 is a perspective view looking into the container of the filter system of FIG. 8 with the door in the open configuration;

FIG. 15 is a block diagram illustrating an automated holding tank washing system according to an exemplary embodiment of the present invention;

FIG. 16 is a perspective view of a custom holding tank door according to an exemplary embodiment of the present invention;

FIG. 17 is a perspective view of a custom holding tank door according to another exemplary embodiment of the present invention;

FIG. 18 is a block diagram illustrating a hydraulic system of a filter system according to an exemplary embodiment of the present invention; and

FIG. 19 is a flow chart illustrating a filtering operation according to an exemplary embodiment of the present invention.

### DETAILED DESCRIPTION

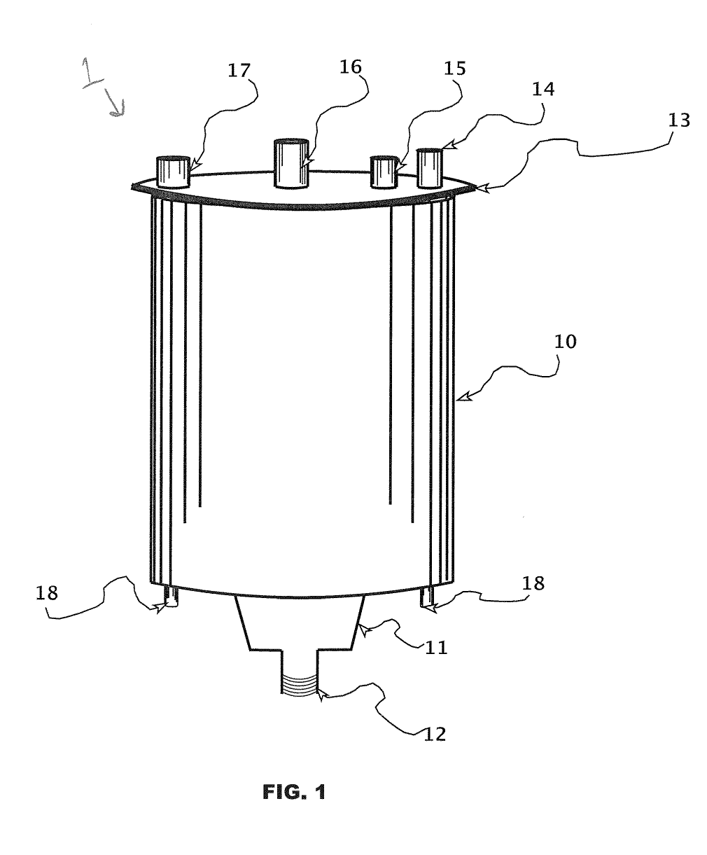

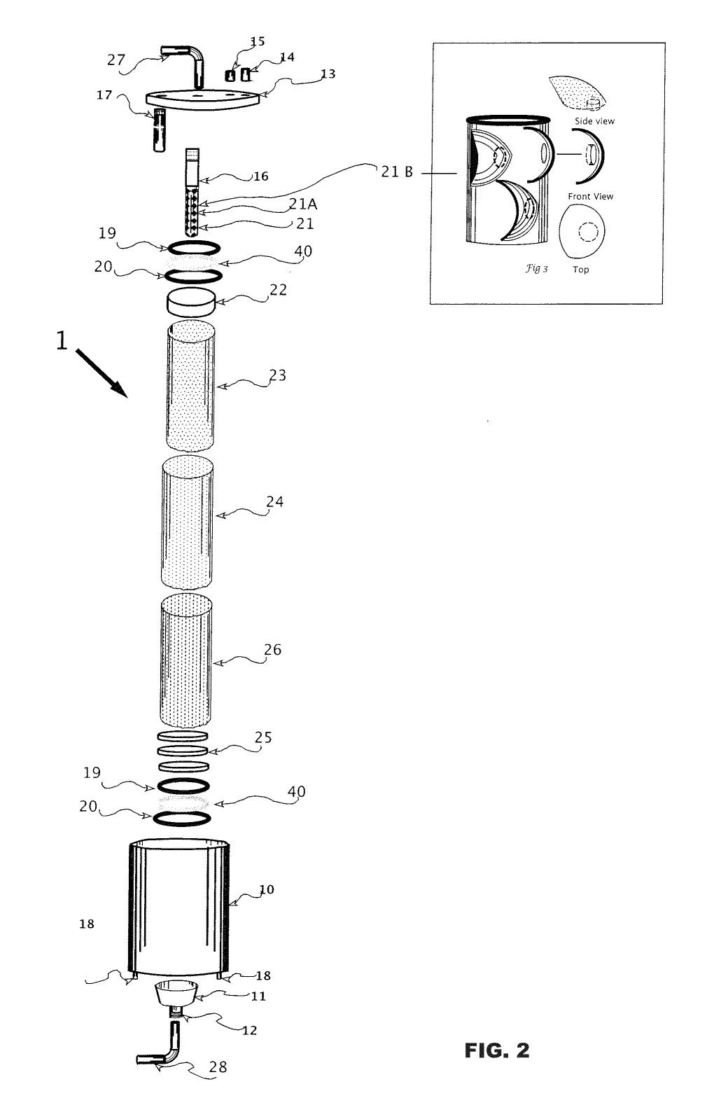

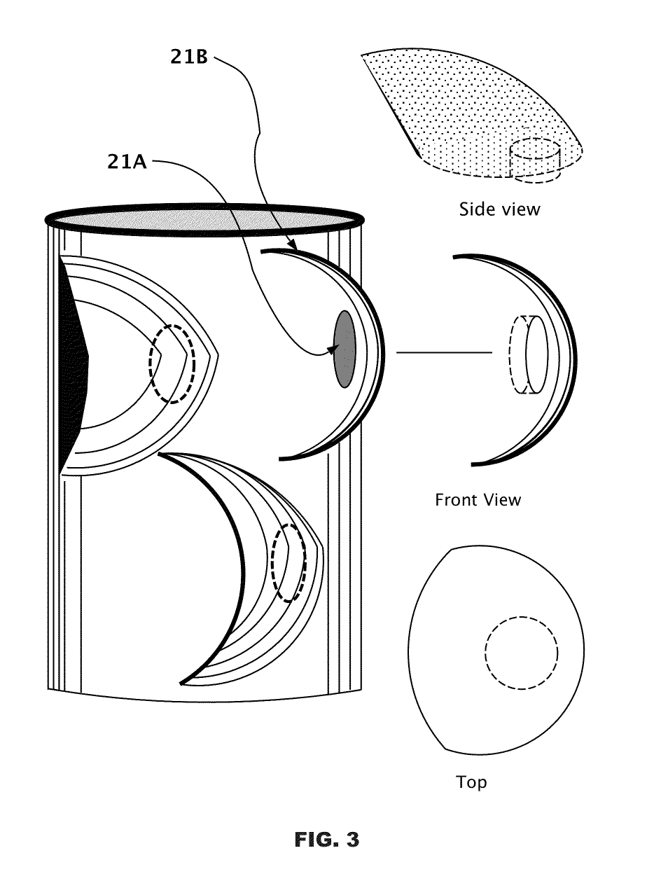

FIGS. 1 and 2 illustrate a water filter, generally designated by reference numeral 1, according to an exemplary embodiment of the present invention. Water filter 1 includes a housing 10, large piece debris basket 11, fitting 12, small, heavy particle outflow pipes 18 extending from the bottom of the housing 10, and a lid 13 with a retaining collar and seal that encloses the top of the housing 10. The size of the housing 10 may be selected according to the required capacity of the filter 1. An oil outflow pipe 14, a small, light particle outflow pipe 15, a main contaminated water inflow pipe 16 and discharge pipe 17 may pass through the lid 13. All of the pipes may have valves that control their rate of flow and which can be adjusted in order to control the operation of the filter 1. Discharge pipe 17 extends downwards into the perimeter of the housing 10 to draw filtered water out from below the floating oil and debris.

As described in more detail below in regards to this embodiment, filter components are disposed within the housing 10. If there is too much inflow pressure due to an imbalance between the inflow and outflow of water relative to the filter components, small particles and oil may pass through the filter 1 and float to the top of the clean water area. The balance of pressures achieved through use of the various inflow and outflow pipes of the filter 1 substantially reduces passage of the particles and oil through the filter components.

According to an exemplary embodiment of the invention, the filter components disposed within the housing 10 may include a first filter component 23, a second filter component 24 and a third filter component 26. The filter components 23, 24, 26 may be cylindrical in shape and structured so as to progressively filter the contaminated water. The first filter component 23 may be, for example, 5/32″ perforated 0.22″ galvanized metal. A 6″ high separator ring may be attached and sealed around the top of the first filter component 23 for containing oil within the contaminated water so that the oil does not pass through the filter 1. The separator ring may be, for example, 6″ thick, although this thickness value is not intended to be limiting. The second filter 24 may be, for example, a 200-mesh, grade T316 stainless steel gauge 0.002″ screen. In an exemplary embodiment of the invention, the housing 10 is designed such that the second filter 24 can be easily removed and replaced with other filters having different mesh sizes, such as, for example, 60 mesh to 800 mesh, so as to accommodate different sized debris. The third filter component 26 may be made of, for example, 16 gauge steel with ¼″ holes. The filter components 23, 24, 26 may be bound by bands 25 so that the filter components 23, 24, 26 do not bellow out or separate. The bands 25 may have a diameter of, for example, 24″, and dimensions of, for example, ⅛″×1″. Heavy, but small particles that are not collected in the debris basket 11 settle out to the edge of the bottom of the housing 10 on the clean water side and are discharged via pipes 18. The filter components 23, 24, 26 may be sealed in place with gaskets 40, each of which may be held between two metal rings 19, 20.

It should be clearly understood that the minimum size of the particles to be screened can be adjusted according to the mesh of the screen used in the second filter component 24. It should also be clearly understood that while water is the preferred aqueous solution, the filter system embodied herein can be used to filter other liquid solutions and solids.

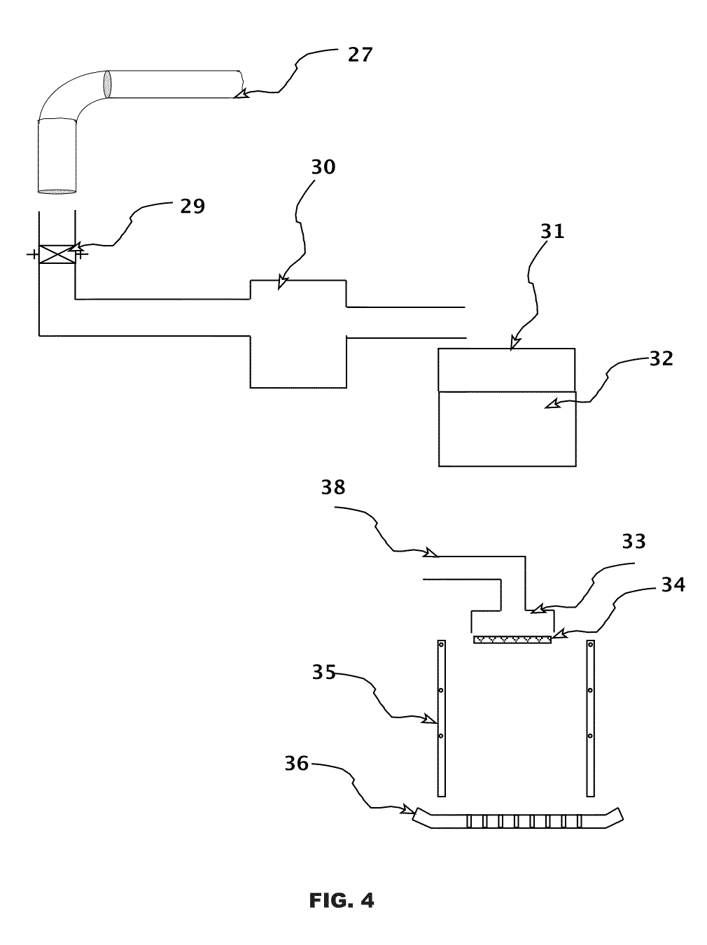

As shown in FIG. 4, contaminated water may be suctioned from a pit through a hose using a pump 30. The pump may be rated at, for example, 0-25 psi. The flow rate may be adjusted to keep the filter pressure between 0-5 psi. As the pond drains, the level in the filter intake 33 lowers with the water level inside the filter 1 and requires more suction. To achieve this, the pump speed may be increased, preferably while the pressure at the discharge pipe 17 remains at 0-3 psi. The debris volume may be monitored through a viewing section 27, which may form a part of the contaminated water inflow pipe 16, located on the top of the lid 13. The viewing section 27 may be made of transparent material, such as, for example, glass or plastic. A flowmeter may be used to keep a volume count on the water inflow coming through the inflow pipe 16 for control purposes. As shown in FIG. 2, another debris viewing section may be attached and located at bottom cleanout 28. Adjustments may be made to the flow rates so that the bottom cleanout 28 does not get clogged with sand, mud or other debris.

In an exemplary embodiment of the invention, contaminated water inflow fills the inflow pipe 16 and is propelled from the inflow pipe 16 into a cyclonic motion with varying speeds at different levels of the inflow pipe 16. Specifically, the water exiting the central portion of the inflow pipe 16 may have the greatest rotational speed whereas the water exiting upper and lower portions may have lower speeds. The inflow pipe 16 may include, for example, a first section including a 4 inch wide steel, threaded, solid pipe section of 12 inch length and a second section 21 that is welded to the first section and which includes 15½ inch long, 14 gauge steel, rolled and welded into a tube with a closed bottom that has two alternating columns of holes 21A, the first column being of five units, the second column being of six units, all having angled louvers 21B and alternating around the circumference of the inflow pipe 16. The holes 21 may have a diameter of, for example, one inch has four rows of six holes 5 inches on center, to which the exit louvers 21B, are attached. These louvers 21B are about two and half inch cylinders, angular cut and welded around the hole. The louvers 21B are angled so as to direct the flow of water in a circular motion. The bottom of the pipe 16 is welded close to complete the assembly. The louvers 21B are positioned in a central location along the inflow pipe 16 and are not present near the ends of the pipe, thus effecting a greater rotational speed in the central portion of the inflow pipe 16.

The design embodied in this exemplary embodiment of the invention uses these separate layers to generate a circular flow within the filter 1 and to segregate the components of the contaminated water in conjunction with gravity. The holes 21A and the louvers 21B control the speeds and flow at the different levels. The separation of the different layers and the speed of the rotating water are important to the function of the gentle outflow through the filter screens. The oil layer and light debris will tend towards the upper portion of the filter where the rotational speed is reduced so as to exert minimal flow pressure, while heavier sand and large debris will tend downwards due to gravity. If the flow pressure is too great it can force the oil through the filter screens compromising the efficiency of the filter. The sandwiched filtration media restrains the larger particles of debris which are then collected at the large particle collector 12. Smaller particles are filtered and float to the top and exit through a small particle outflow pipe 15. The oil is removed through an oil outflow pipe 14.

As shown in FIG. 4, an exemplary embodiment of the present invention may include a pre-filter. The pre-filter prohibits large stones, debris, etc. from entering the filter 1. Additionally, the pre-filter provides the first separation of oil from entering the filter system. A hose from the inflow pipe 16 to the contaminated pond connects the pre-filter to the main filtering system. An air chamber 31 keeps the pre-filter floating on the surface of the oil and the water mixture. As the oil sometimes mixes with the water and sits below the main exposed oil level, an intake pipe 38 may extend through the air chamber 31 and spread out to a vacuum intake chamber 33. On the lower side of the vacuum intake chamber 33 is a large size opening with a mesh screening 34. The mesh screening 34 sits at the bottom of the vacuum. The vacuum intake chamber 33 and mesh screening 34 are located away from the bottom of the air chamber 31 so as to prevent oil floating on top of the water from entering into the vacuum intake chamber 33. Side baffles 32 may be used to contain the turbulence in the water that is created when the water is suctioned into the intake chamber 33, thereby inhibiting oil from mixing into the water. The entire assembly may be attached to support legs 35, which sit on a sled 36. The height of the sled 36 may be adjustable depending upon the type of material being suctioned from the ponds. The sled 36 may have holes drilled in the bottom to allow water to circulate up into the intake chamber 33. As the water level goes down, the sled 36 keeps the vacuum off of the sludge area at the base of the pond. The type and density of the sludge may be monitored through the sight glass 27 located just before the water enters the main filter 1. A valve 29 and pump 30, such as, for example, a 0-25 psi pump with a capacity of 0-400 gallons per minute, may be used to control the volume and flow of water.

An additional aspect of this exemplary embodiment of the present invention is the ability of the pump 30 to be reversed. This is particularly useful in situations when the contaminated water is relatively clean and has primarily small particles. Another advantage of being able to run the filter in reverse is to flush out the filter 1 and clear out any potential clogs.

The ability to run the filter 1 in reverse provides significant gain in efficiency in field use. An exemplary embodiment of the present invention using a combination of a pre-filter and main filter may generally achieve a pumping rate of about 100 to 350 gallons/minute of water during operation, depending on the degree of contamination. This is a rate comparable to a sock filter. However, whereas the present exemplary embodiment of present invention can fill up a truck of water in about 25-40 minutes at this pumping rate, the sock filter may be changed 1-3 times during the course of loading the truck, with each change taking about 10 minutes. Further, a tear in the sock or mishandled change can contaminate an entire truck. The filter 1 may be run constantly as it is self-cleaning, by adjusting the flow valves, thus keeping the filtration system in continuous operation.

In an exemplary embodiment of the invention, the entire filter assembly may sit on a trailer, which also contains the pumps and hoses connecting the filters. The floor of the trailer may have angular siding that prevents any potential spills from reaching the ground level.

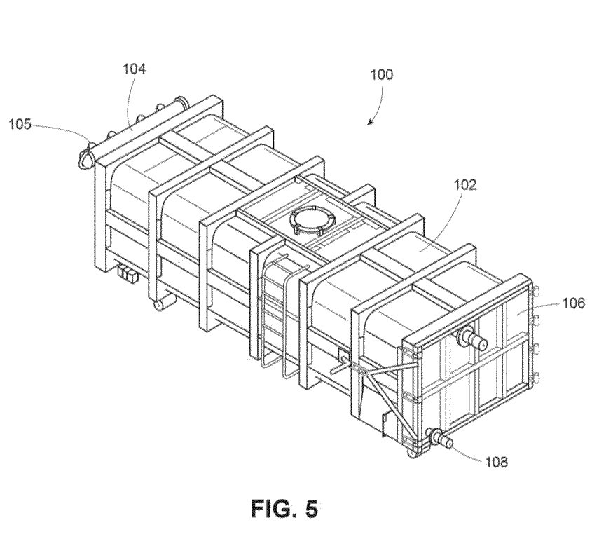

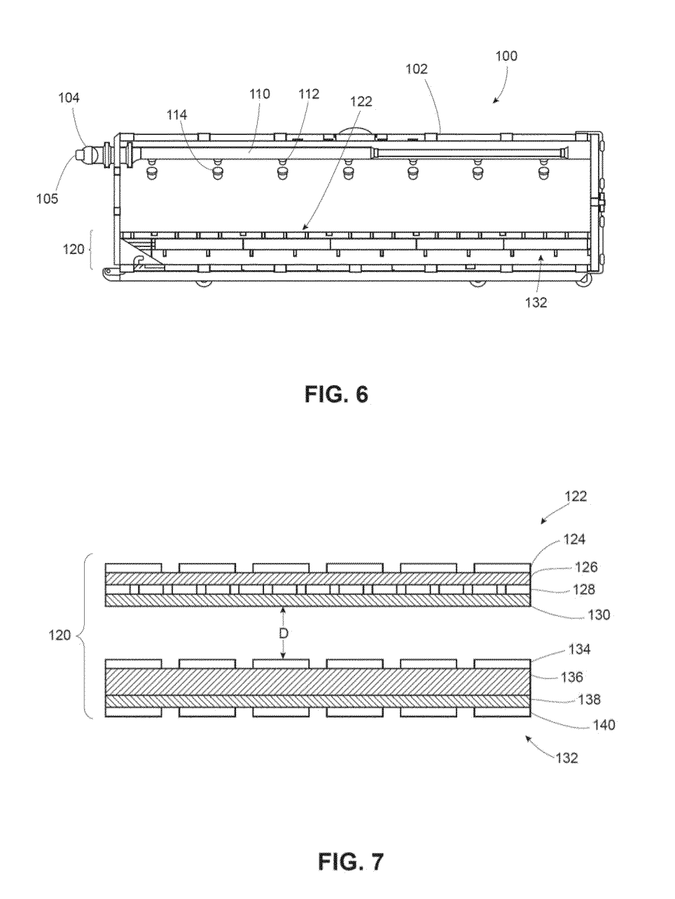

FIG. 5 is a perspective view of a filter system, generally designated by reference number 100, according to another exemplary embodiment of the present invention and FIG. 6 is a cross-sectional view of the filter system 100. The filter system 100 may be used to filter out solids from contaminated liquids, such as, for example, water, diesel fuel, crude oil, saltwater, invert drilling liquid, and liquids originating from sewage lagoons, to name a few. Accordingly, the filter system 100 may be useful in operations involving, for example, oil drilling, hydro vacuuming, hydro excavation, mining and hydraulic fracturing.

The filter system 100 includes a generally rectangular-shaped container 102 made of, for example, steel. The container 102 may have a capacity within the range of 1 cubic yards to 30 cubic yards for mobile units, and up to 200 cubic yards for permanent placement units. It should be appreciated that the capacity of the container 102 is not intended to be limited to any particular value. For example, in embodiments, the capacity of the container may be 0.5 cubic yard to 200 cubic yards or higher.

The container 102 may be able to withstand approximately 27 pounds of vacuum. An external inflow pipe 104 is mounted on the container 102 and in communication with internal pipes 110 that are housed within the container 102. In this regard, the external inflow pipe 104 may include one or more external inflow ports 105 to which one or more intake hoses (not shown) may be attached.

The internal pipes 110 may include one or more branches (not shown) as they traverse across the container 102 so as to reduce pressure of the liquid entering the external inflow pipe 104 at high speeds. For example, each internal pipe 110 may have a diameter of 6 inches, and the pipe 110 may branch out to two more pipes each having a diameter of 8 inches.

As shown in FIG. 6, the internal pipes 110 include nozzles 112 through which the incoming liquid is directed onto shield elements 114. The shield elements 114 may include steel plates that are angled so as to shield the sidewalls of the container 102 from the liquid leaving the nozzles 112. The shield elements 114 prevent damage of the side walls from the high pressure liquid, while allowing the liquid to still travel downwards onto and disperse over the filter assembly 120 located at the bottom portion of the container 102. In this regard, the interior walls of the container 102 may also include a protective coating, such as, for example, epoxy resin-based coatings (such as Carboguard 8845 DTM, commercially available from Carboline Company, of St. Louis, Mo., USA), conductive polymer nanodipersions (CPNDs) (commercially available from AnCatt Inc., of Newark, Del., USA), and/or bioplastics (such as Ecodur 201 and FracShield, both commercially available from Castagra Products, Inc., Reno, Nev., USA). The protective coating allows the filter system 100 to operate under extreme conditions that are present during, for example, oil drilling, where the fluid inflow may be as high as 240° F. and contain corrosive materials, such as oils, salts and acids.

As explained in more detail below, the filter assembly 120 filters out solids from liquid that is piped into the container 102, and the filtered liquid is removed from the container 102 through outflow port 108. The outflow port 108 is disposed below the filter assembly 120 and, as shown in FIG. 5, may extend through the back wall of the container 102. The container 102 operates under vacuum so that the liquid is drawn through the filter assembly 120 and through the outflow port 108, leaving behind the filtered particulate material within the container 102. The container 102 may include an opening at one end covered by a door 106 that can opened for removal of the particulate material. According to an exemplary embodiment, the container 102 may be configured for attachment to a waste collection vehicle that transports the container 102 to a waste treatment facility and dumps the filtered particulate material out of the container 102 through the door 106. In this regard, any suitable latching or locking mechanism may be used to operate the door 106. Prior to disposal of the collected waste, the external inflow pipe 104 may be closed via an inlet valve and vacuum may be applied to dry the filtered waste materials, thus allowing for easier disposal.

FIG. 7 is a cross-sectional view of a filter assembly 120 that is supported within the container 102. The filter assembly 120 includes an upper filter assembly 122 and a lower filter assembly 132. The upper filter assembly 122 may be supported within the container 104 on a sub-floor 130 that is welded or otherwise made integral with the container 102. In this regard, the sub-floor 130 may be made of, for example, spaced structural tubing. The upper filter assembly 122 includes an upper filter assembly top layer 124, an upper filter assembly intermediate layer 126 and an upper filter assembly bottom layer 128. The upper filter assembly top layer 124 may be made of a stainless steel (type A36) perforated plate having ½″ diameter holes with an 11/16″ stagger. The upper filter assembly intermediate layer 126 may be made of a 40 mesh stainless steel (type 304) woven wire. The upper filter assembly bottom layer 128 may be made of a stainless steel (type 304) perforated plate having 1/16″ diameter holes with an ⅛″ stagger.

The lower filter assembly 132 may be spaced vertically downwards from the upper filter assembly by a distance D of, for example, 3 inches, and may include a lower filter assembly top layer 134, a lower filter assembly first intermediate layer 136, a lower filter assembly second intermediate layer 138 and a lower filter assembly bottom layer 140. The lower filter assembly top layer 134 may be made of a stainless steel (type A36) perforated plate having ½″ diameter holes with an 11/16″ stagger. The lower filter assembly first intermediate layer 136 may be made of aggregate, such as, for example, coal slag, iron ore slag, finely crushed granite, and coarse sand. In general, the size of the aggregate may be in the range of 1/64″ to 1/32″ in diameter. The lower filter assembly second intermediate layer 138 may be made of a 20 mesh stainless steel (type 304) woven wire. The lower filter assembly bottom layer 140 may be made of a stainless steel (type A36) perforated plate having ½″ diameter holes with an 11/16″ stagger.

It should be appreciated that the various materials and sizes mentioned above are not intended to be limiting, and any other suitable materials and sizes may be used to achieve the desired filtering. For example, the filter assembly 120 may have more than two filter sub-assemblies, with each sub-assembly having multiple layers not necessarily limited to the three-layer sub-assemblies described previously, such as a five-layer filter sub-assembly. Further, the layers may be made of materials other than those mentioned previously, such as, for example, polypropylene, sand, diatomaceous earth, zeolite and/or obsidian, to name a few. The total square feet of filter material (calculated by L×W of each layer multiplied by the number of layers) may be within a range of, for example, 300 square feet to 1000 square feet, although the total square footage may be outside this range.

The filtered water that collects at the bottom of the container 104 below the upper and lower filter assemblies 122, 132 may be sucked out of the container 104 through the outflow pipe 108 via a vacuum source (not shown).

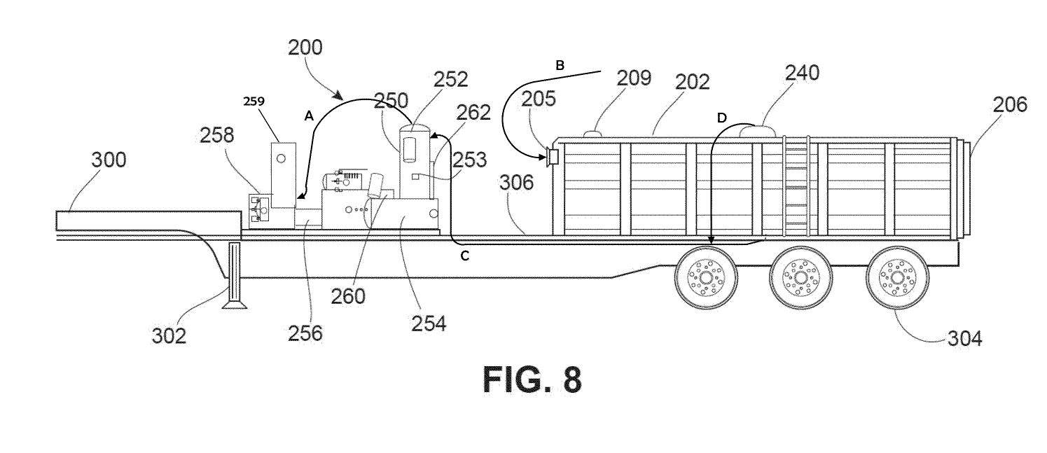

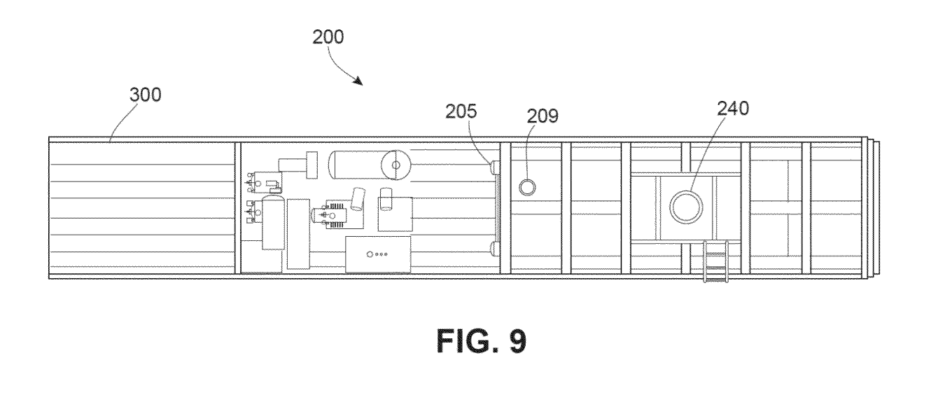

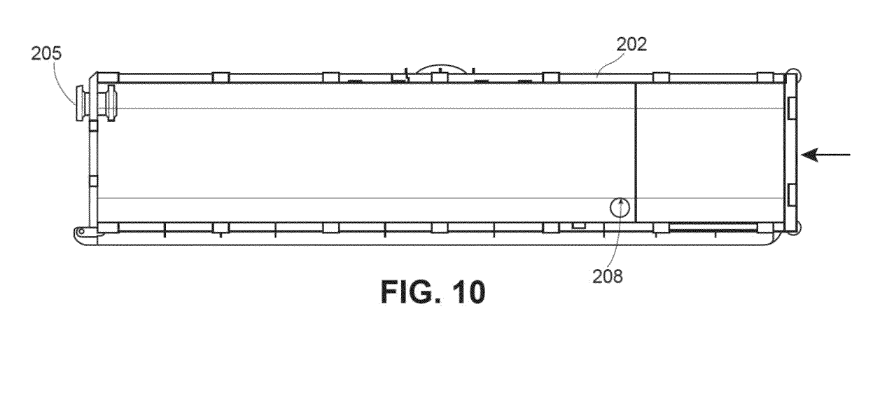

FIGS. 8-10 and 12-14 illustrate a filter system, generally designated by reference number 200, according to another exemplary embodiment of the present invention. The filter system 200 includes generally the same components as the filter system 100, including a container 202, inflow port 205, door 206, outflow port 208, internal pipes 210, nozzles 212, shield elements 214 and filter assembly 220. The outflow port 208 extends through a side wall of the container 202. The container 202 may also include an auxiliary inflow port 209 and a manway 240. As explained in further detail below, the manway 209 allows for suction of free floating solids that is not intended to go through the filter assembly 220.

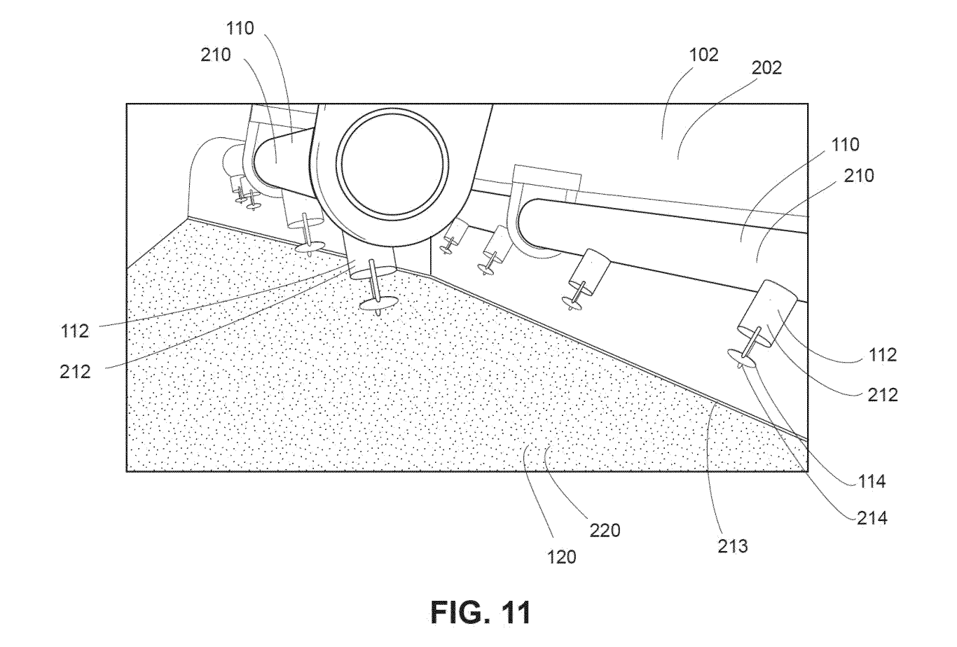

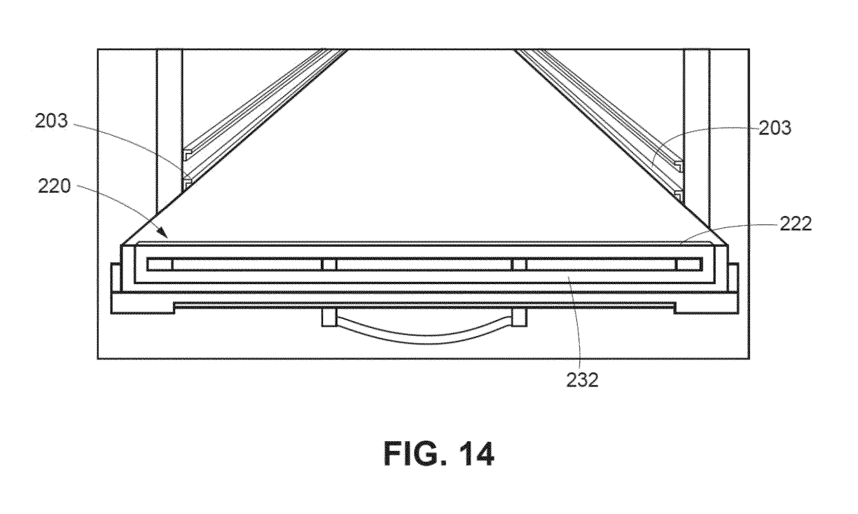

As shown in FIG. 14, the filter assembly 220 includes an upper filter assembly 222 and a lower filter assembly 232. Each of the upper and lower filter assemblies 222, 232 may be made of materials and be sized as described with reference to the just previous embodiment, and additional filter sub-assemblies may be provided. The filter assembly 220 may be slid along rails 203 provided along the inner walls of the container 202 so that the filter assembly can be removed for cleaning or replacement. As shown in FIG. 11, a gasket 213 may be provided around the filter assembly 220 to prevent liquid from flowing between the filter assembly 220 and the walls of the container 202. In this regard, the gasket 213 may be attached to the filter assembly 220 along the front and sides of the filter assembly 220 before the filter assembly 220 is slid into the container 202. The filter assembly 220 is slid completely into the container 202, at which point the front portion of the gasket 213 seals against the container 202 back wall and the side portions of the gasket 213 seal against the container 202 side walls. The back portion of the gasket 213 is sealed by the door 206 when in the closed position. The gasket 213 may be made of, for example, buna rubber, Viton (commercially available from DuPont Performance Elastomers L.L.C., of Wilmington, Del., USA), EPDM (ethylene propylene diene monomer (M-class) rubber), and/or silicone.

The filter system 200 further includes transfer tank 250, a water pump 256, a vacuum source 259, an engine 260 that provides power to the water pump 250 and vacuum source 259 and one or more traps 258. The vacuum source 259 may be, for example, a lobe blower, a more specific example being a tri-lobe blower commercially available from National Vacuum Equipment, Inc., of Traverse City, Mich., USA. As shown by arrow A in FIG. 8, the vacuum source sucks air from the top of the transfer tank 250 so as to create a vacuum that pulls contaminated liquid into the container 202 and through the filter assembly 220, and filtered liquid out of the container 202 into the transfer tank 250. Specifically, as shown by arrow B, contaminated liquid is sucked into the container 202 through inflow port 205 and, as shown by arrow C, filtered liquid is sucked out of the container 202 through outflow port 208. In an exemplary embodiment, the transfer tank 250 includes a first portion 252 that is generally funnel shaped so that the liquid has a vortical flow as it enters the transfer tank 250. The vortical flow prevents the liquid from mixing with the air being pulled into the vacuum source 259. After passing through the first portion 252, the liquid flows into a second portion 252 of the transfer tank 250, which is below the first portion 252. An electrical sensor 253 is disposed within the first portion 252 of the transfer tank 250 and measures the liquid level. When the liquid reaches a predetermined level, the electrical sensor 253 sends a signal to trigger operation of the water pump 256. The water pump 256 then generates a vacuum to suck the filtered liquid through at a faster rate. In this way, the liquid extraction rate is able to match the influent flow rate and the interior of the container 202 is maintained in vacuum. As the solids collect above the filter assembly 220, the vacuum generates pressure on the solids, which in turn results in relatively more efficient and thorough removal of the solids from the liquid. It should be appreciated that a plurality of water pumps 256 may be provided as needed to generate the appropriate liquid extraction rate to match the liquid intake rate. Also, a first vacuum gauge 211 may be disposed above the filter assembly 220 and a second vacuum gauge 213 may be disposed below the filter assembly so as to assess effectiveness and optimum functionality. For example, the first and second vacuum gauges 211, 213 may be used to monitor the variation in resistance provided by the filter assembly 220 so an operator can determine whether the filter assembly 220 is becoming clogged or whether the filtering operation needs to be sped up. For added safety, the container 202 may include a pressure and vacuum relief valve to prevent blowing up and collapsing of the container 202.

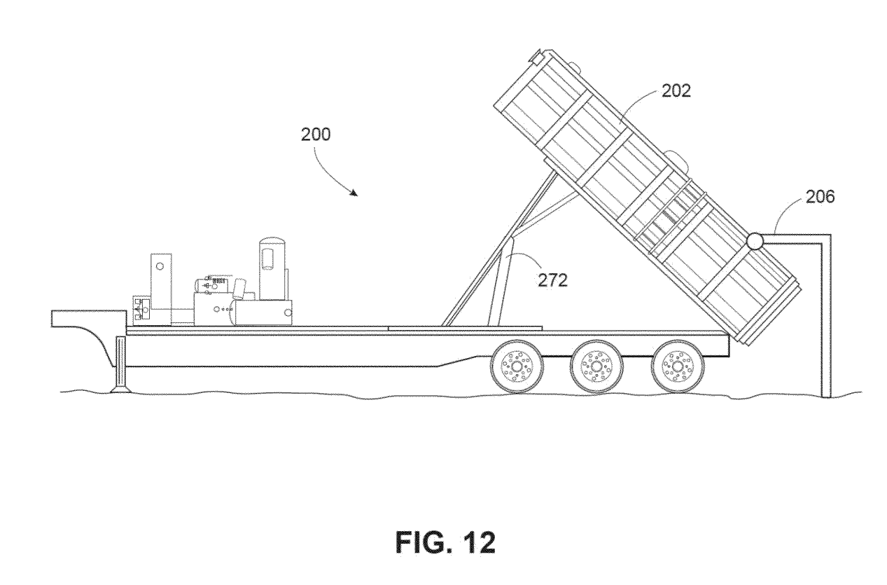

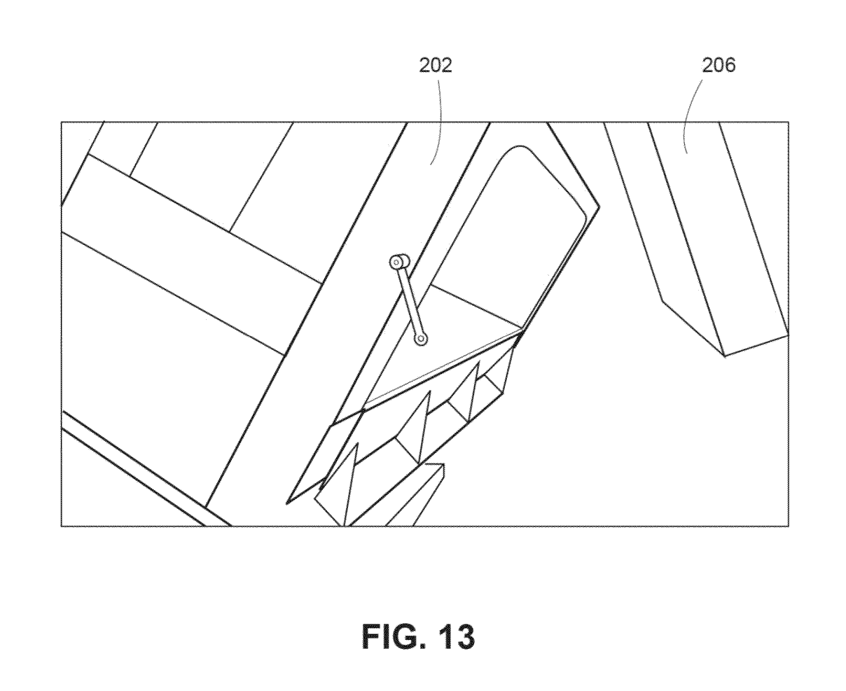

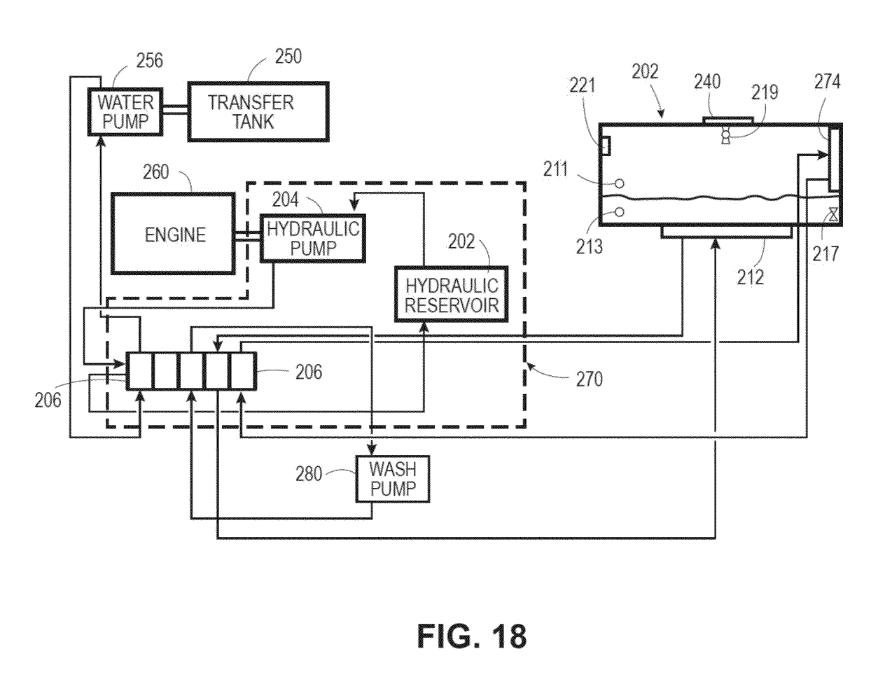

FIG. 18 is a block diagram showing a hydraulic system, generally designated by reference number 270, of the filter system 200 according to an exemplary embodiment of the present invention. The hydraulic system 270 includes a hydraulic reservoir 202 that stores hydraulic fluid and a hydraulic pump 204 that pumps hydraulic fluid between the hydraulic reservoir 202 and hydraulic blocks 206. The hydraulic pump 204 is powered by the engine 260. The hydraulic blocks 206 supply the hydraulic fluid to the various hydraulically operated mechanisms of the filter system 200, including the water pump 256, wash pump 280 (discussed below), and lift pistons of the lift 272 and door 274. In this regard, FIGS. 12 and 13 illustrate a dumping operation of the filter system 200 that takes place after a filtering operation has been completed. In FIG. 12, the container 202 is shown in a dumping configuration with the lift 272 extended so that the end opposite the door 206 is lifted off the bed 306 of the semi-trailer 300. In FIG. 13, the door 206 is shown in an open configuration so that solids within the container 202 can be dumped out. The door 206 is preferably sized so that it does not expose the inside of the container 202 below the filter assembly 220. This prevents any liquid that may still be present below the filter assembly 220 from dumping out with the solids.

The filter system 200 also includes a manway 240 positioned on the top of the container 202. The manway 240 allows for vacuuming of material off the top of the liquid held in the container 202, such as, for example, oil, gasoline, petroleum products or any other materials that are less dense than water. In this regard, the filter system 200 includes a shut off, such as valve 217, for the vacuum below the filter assembly. This allows for the less dense material to rise to the surface of the liquid, at which point, as shown by arrow D in FIG. 8, such material may be vacuumed off through the manway 240. In the case in which the less dense material is oil or petroleum products, such “free product” may be further filtered for reuse after being vacuumed off the liquid in the container 202. The manway 240 may include a vacuum break, such as ball valve 219, that blocks the vacuum when the liquid gets too high.

Operation of the vacuum shut off may be based on a mechanical float control 221, such as a float switch, disposed within the container 202. Upon the liquid reaching a predetermined level within the container 202, the float control 221 activates the shut off, thereby stopping the vacuum below the filter assembly 220. As discussed, the less dense material can then float to the top of the liquid and be suctioned off through the manway 240.

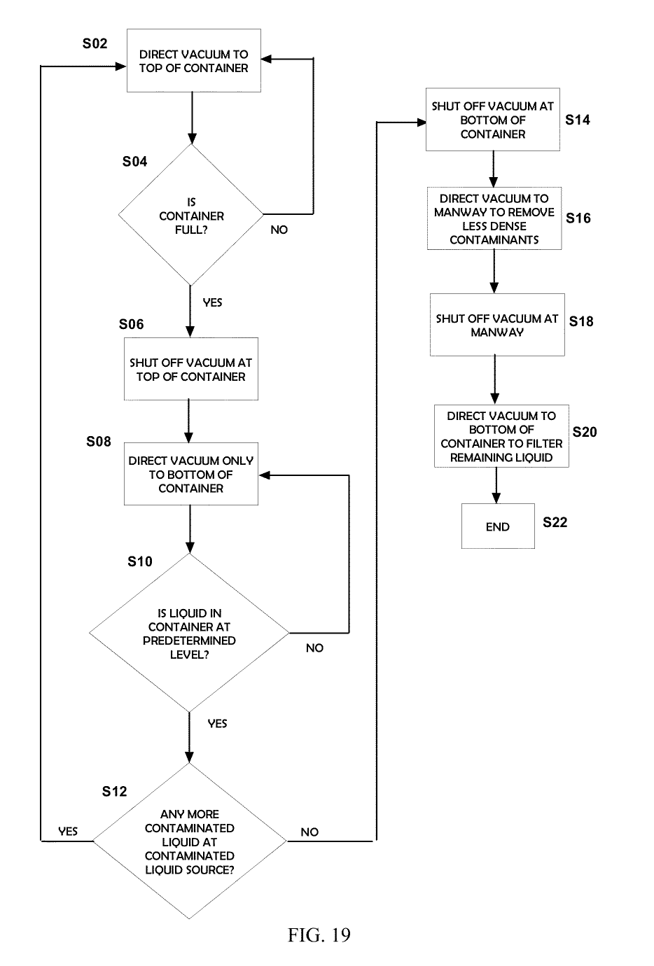

FIG. 19 is a process flow of a filter operation according to an exemplary embodiment of the present invention. In step S02 of the operation, vacuum is directed to the container 202 to draw contaminated liquid into the container 202 through the inflow port 205. In step S04, it is determined whether the container 202 is full. If the container is not full, the contaminated liquid continues to be vacuumed into the container 202. Once the container is full, in step S06, the vacuum at the top of the container is shut off, and in step S08, vacuum is directed only to the bottom of the container 202 to draw out filtered liquid through the outflow port 208. In step S10, it is determined whether the liquid in the container has decreased to a predetermined level (for example, to the halfway point of the container 202). If so, the filter operation proceeds to step S12. Otherwise, vacuuming continues until the predetermined level is reached.

Controlling the top level of the liquid within the container 202 so that the level does not reach the filter assembly 220 prevents less dense contaminants, such as gels, from clogging the filter assembly 220. In step S12, if it is determined that there is no more contaminated liquid at the source, the operation proceeds to step S14, where vacuum to the bottom of the container is shut off and, at step S16, vacuum is directed to the manway 240 so that the less dense contaminants can be removed through the top of the container 202 (rather than through the filter assembly 220). After removal of the less dense contaminants, the vacuum is shut off at the manway in step S18, and in step S20 vacuum is again applied to the bottom of the container to filter the remaining liquid in the container 202. The filtering operation then ends at step S22.

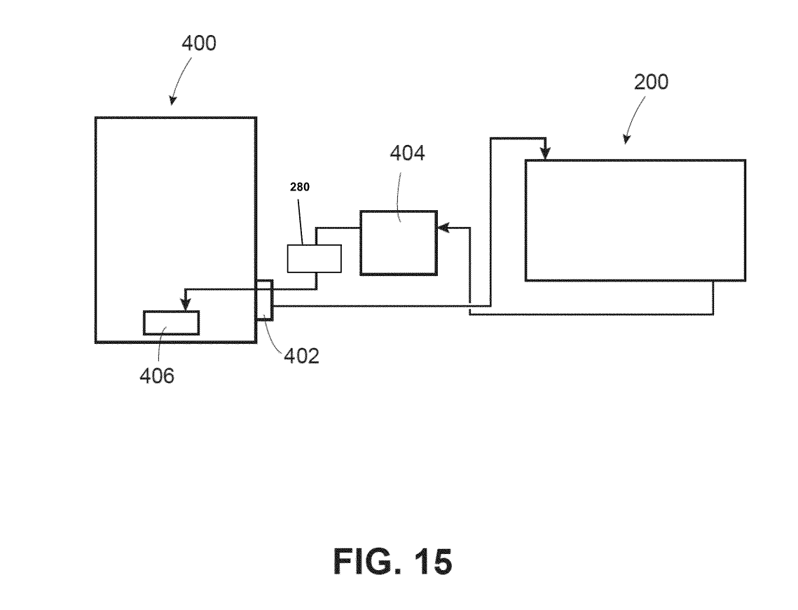

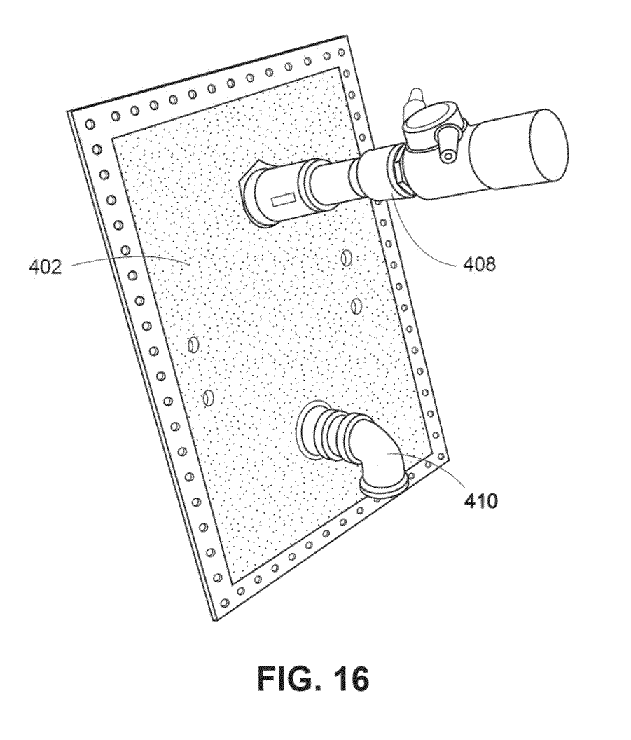

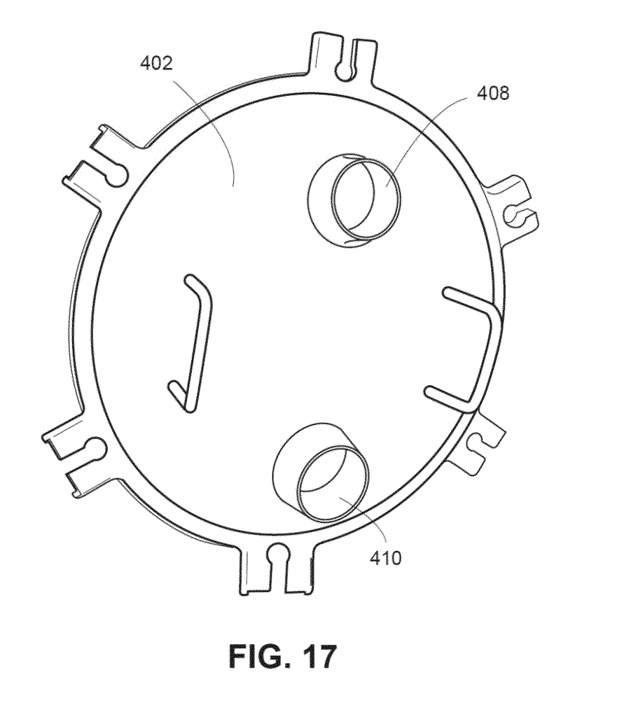

The filter system 200 has many applications, and in particular may be used for washing inside surfaces of holding tanks, such as, for example, oil field frac and upright tanks, septic cleaning vacuum tanks, over the road tanker trucks, rail cars and brewery tanks, to name a few. The conventional washing method often requires laborers, certified in and using Confined Space Entry (CSE), to directly enter the holding tank to manually spray high pressure fresh water and cleaning chemicals to return interior surfaces to original condition, which also presents the employer and customer with significant health risks impacting the laborers and does not allow or enable beneficial re-use or recycling of the washing liquid. As shown in FIG. 15, the filter system 200 includes an automated tank washing system that eliminates the need for CSE laborers to enter the holding tank to achieve an acceptable washing outcome with the added benefit of recycling and re-using the wash liquid. In particular, the system offers the added benefit of delivering hot water to the spray head 406 within the tank 400 through a custom holding tank port door 402 which allows for continuous inbound spray liquid and simultaneous vacuuming of waste content. The resulting solids and liquid from the automated tank washing system now includes solids and other debris from inside the tank, which are simultaneously vacuumed through the custom holding tank port door 402 and conveyed using high cfm vacuum to the filter system 200 where the mixed material is simultaneously, in real time, rapidly filtered to separate the solids from the liquids. In this example the filtered liquids are returned to wash liquid tank 404 for the ongoing supply of spray liquids to the wash pump 280 and spray head 406. The custom holding tank port door 402 is provided to the job site to temporarily replace the conventional holding tank door to accomplish the above. In particular, as shown in FIGS. 16 and 17, the door 402 may be shaped as appropriate to cover the tank opening in place of the conventional door and further includes inflow port 408 and outflow port 410.

While particular embodiments of the invention have been illustrated and described, it would be obvious to those skilled in the art that various other changes and modifications may be made without departing from the spirit and scope of the invention. It is therefore intended to cover in the appended claims all such changes and modifications that are within the scope of this invention.

What is claimed is:

1. A filter system comprising:
a vacuum source for generating a vacuum flow; and
a container comprising:
an inflow port for receiving contaminated liquid;
a filter assembly for filtering solid contaminants from the contaminated liquid; and
an outflow port for delivering filtered liquid from the container, the vacuum flow proceeding through the container so that the filtered liquid is drawn through the filter assembly towards the outflow port.

2. The filter system of claim 1, wherein the container is made of steel.

3. The filter system of claim 1, further comprising an internal inflow pipe in communication with the inflow port, the internal inflow pipe comprising one or more nozzles for delivery of the contaminated liquid to the filter assembly.

4. The filter system of claim 3, further comprising shield elements that protect the container from contact with the contaminated liquid delivered from the nozzles.

5. The filter system of claim 1, wherein the filter assembly comprises at least one perforated plate and at least one woven screen.

6. The filter system of claim 5, wherein the filter assembly further comprises at least one layer of aggregate.

7. The filter system of claim 6, wherein the aggregate is made up of at least one of coal slag, iron ore slag, crushed granite or coarse sand.

8. The filter system of claim 1, wherein the filter assembly comprises an upper filter assembly and a lower filter assembly.

9. The filter system of claim 1, further comprising an outflow pipe through which filtered liquid is drawn out of the container.

10. The filter system of claim 1, wherein the contaminated liquid comprises at least one of water, sewage, diesel fuel, crude oil, saltwater, invert drilling fluid, dredge material, mining pond water, concrete washout material, paper manufacturing waste water, recycled motor oil and aggregate and sand washing material.

11. The filter system of claim 1, wherein the container has a capacity within the range of 0.1 cubic yards to 200 cubic yards.

12. The filter system of claim 1, wherein the container comprises walls, interior surfaces of the walls being coated with a protective coating.

13. The filter system of claim 12, wherein the protective coating comprises a material selected from a list of materials consisting of: epoxy resin, conductive polymer nanodispersions and bioplastics.

14. The filter system of claim 1, wherein the container further comprises a manway that allows access to the contaminated liquid within the container so that other contaminants may be removed from the top surface of the contaminated liquid.

15. The filter system of claim 1, further comprising a pump that removes the filtered liquid from the container.

16. The filter system of claim 15, further comprising a transfer tank that receives the filtered liquid from the container.

17. The filter system of claim 15, wherein the transfer tank comprises a sensor that determines a level of the filtered liquid in the transfer tank so that upon a condition that the level of the filtered liquid reaches a predetermine level, the pump is activated to maintain operation of the filter system under vacuum pressure.

18. The filter system of claim 1, wherein the container comprises an opening and a door that is moveable between a closed position in which the door covers the opening and an open position in which the door allows solid contaminants to be removed from the container through the opening.

19. The filter system of claim 18, further comprising a lift that moves the container to a dumping configuration.

20. The filter system of claim 19, further comprising a hydraulic system that operates the door and the lift.

21. The filter system of claim 1, wherein the outflow port is disposed below the filter assembly.
